(19) United States
(12) Patent Application Publication
(10) Pub. No.: US 2014/0176041 A1
(43) Pub. Date: Jun. 26, 2014

(54) SEMICONDUCTOR THERMOELECTRIC MODULE CHARGER FOR MOBILE COMPUTING DEVICE

(71) Applicant: NVIDIA CORPORATION, Santa Clara, CA (US)

(72) Inventor: Xiang Sun, Shenzhen (CN)

(73) Assignee: NVIDIA CORPORATION, Santa Clara, CA (US)

(21) Appl. No.: 13/722,387

(22) Filed: Dec. 20, 2012

(51) Int. Cl. H02J 7/00

(52) U.S. Cl. CPC H02J 7/00
USPC 320/101

(57) ABSTRACT

A system and method for recycling the electrical energy that has been consumed and converted into unwanted thermal energy. A power source for supplying power to a mobile computing system comprises a rechargeable battery and a semiconductor thermoelectric module coupled to the rechargeable battery and a charring circuit. The thermoelectric module is disposed proximate to a heat generating member of the computing system and operable to sense the thermal energy released by the member and convert it into electrical energy based on Seeback effect. The converted electrical energy can be regulated and stored in the rechargeable battery.

### TECHNICAL FIELD

The present disclosure relates generally to the field of mobile computing devices, and more specifically to the field of power supplies for computing systems.

### BACKGROUND

The density and speed of integrated circuit elements have steadily and exponentially increased for several decades, allowing for ever faster processing speeds, greater data handling capabilities, increasing storage capacity, and smaller physical dimensions. However, despite the low-power circuit designs as well as many other power reduction techniques conventionally employed in the electronics today, the density and computing power of integrated circuits are limited primarily by power dissipation concerns.

During operation of a semiconductor chip, a considerable portion of electrical energy consumed by the chip is converted into unwanted thermal energy, mainly by the internal resistances of the circuits, accounting for possible rising temperatures of the chip, e.g. rising from room temperature to around 65˜100° C. The issue is especially prominent for multi-core chips that are widely used in smartphones or tablets. A multi-core device is intended to undertake heavy system loads for long working periods, which consumes high power and produces proportionally high thermal energy. The temperature increase can cause reliability issues or even premature failure of a computing device because the integrated circuit elements are designed to operate best at relatively low temperatures. At an elevated operating temperature, electrical signal transmission speeds are slowed down and a chip's operation characteristic may deteriorate over time, thereby resulting in a reduced device lifetime.

Thus, computing devices and included circuitry typically should be maintained at a relatively low temperature to achieve optimal performance, improve reliability and prevent premature failure. The prevalent approach is to dissipate the heat generated inside the device to the ambient environment, for instance, by a heat sink and/or a fan installed in the device. However, in mobile computing devices, such as laptops, PDA, media players, touchpads, smartphones, etc., it is difficult to employ a sufficiently efficient heat sink or create a heat radiating environment at system level due to the constraints of limited spaces.

Furthermore, the generation of thermal energy unfortunately constitutes a waste of valuable power supplied by the slim battery typically fitted in a mobile computing device. With the functions of mobile computing devices increasingly expanded and refined, users have demanded longer continuous runtimes of mobile devices. Thus, the operating lifetime of a battery has become one of the critical features of such products as it determines the utility of the mobile device in the normal situation where wall power is not easily accessible.

### SUMMARY OF THE DISCLOSURE

Therefore, it would be advantageous to provide a mechanism to efficiently maintain low operating temperatures of an electronic device. It would be also advantageous to improve overall power consuming efficiency of a mobile computing device. Embodiments of the present disclosure provide theses advantages.

Accordingly, embodiments of the present disclosure provide a mechanism to absorb the unwanted thermal energy of an electronic device and recycle it back into electrical energy that is usable to power the device, thereby increasing power efficiency. Embodiments of the present disclosure advantageously employ a thermoelectric module coupled with a rechargeable battery through a charging circuit. The thermoelectric module is capable of sensing and converting thermal energy released from a heat generating component into electrical energy, and advantageously charging the rechargeable battery with the converted electrical energy.

In one embodiment of the present disclosure, a computing system comprises a heat generating component operable to release thermal energy during operation thereof, and a battery system comprising a thermoelectric module operable to sense the released thermal energy, and further operable to convert it into converted electrical energy. The thermoelectric module comprises at least one thermal electrical material selected from a group consisting of Bi₂Te₃, Bi₂Se₃, PbTe and alloys thereof. The battery system further comprises a rechargeable battery coupled to the thermoelectric module through a charging circuit, to supply power to the mobile computing system. The charging circuit is operable to activate or deactivate charging the rechargeable battery with the converted electrical energy.

In another embodiment of the present disclosure, a power source for supplying power to a mobile computing system comprises a rechargeable battery, an internal charging circuit, and a thermoelectric battery comprising a first and a second surface, all coupled to each other. The thermoelectric battery is operable to sense a temperature difference between two surfaces, generate electrical energy in response thereto, and charge the rechargeable battery with the generated electrical energy through the internal charging circuit. The thermoelectric battery comprises at least one thermal electrical material selected from a group consisting of Bi₂Te₃, Bi₂Se₃, PbTe and alloys thereof. The first and the second surface may be disposed proximate to a core chip and an exterior housing member, respectively. The internal charging circuit may comprise charging control logic operable to: 1) active charging the rechargeable battery with the generated electrical energy when the temperature difference is above a threshold; and 2) deactivate the charging when the rechargeable battery is determined to be sufficiently charged.

In another embodiment of the present disclosure, a method for supplying power to a mobile computing system comprises: 1) sensing a thermal energy generated by operation of said mobile computing system; 2) converting the sensed thermal energy into an electrical current; and 3) charging a rechargeable battery with the electrical current. The rechargeable battery is operable to supply power demanded by the mobile computing system. Converting the thermal energy into electrical current comprises creating a voltage difference and producing a current in response. The method may further comprise activating the charging when the voltage difference is above a threshold value, and/or deactivating the charging when the rechargeable battery is determined to be sufficiently charged.

The foregoing is a summary and thus contains, by necessity, simplifications, generalizations and omissions of detail; consequently, those skilled in the art will appreciate that the summary is illustrative only and is not intended to be in any way limiting. Other aspects, inventive features, and advantages of the present invention, as defined solely by the claims, will become apparent in the non-limiting detailed description set forth below.

### BRIEF DESCRIPTION OF THE DRAWINGS

Embodiments of the present disclosure will be better understood from a reading of the following detailed description, taken in conjunction with the accompanying drawing figures in which like reference characters designate like elements and in which:

FIG. 1 illustrates a configuration of an exemplary battery system that comprises a thermoelectric module and a rechargeable battery in accordance with an embodiment of the present disclosure.

FIG. 2 is a flow diagram illustrating an exemplary process for recycling thermal energy back into electrical energy in a mobile computing system by using a thermoelectric module and a rechargeable battery in accordance with an embodiment of the present disclosure.

FIG. 3 is a functional block diagram illustrating the configuration of a mobile computing device that comprises two thermoelectric module coupled with other functional components in accordance with an embodiment of the present disclosure.

### DETAILED DESCRIPTION

Reference will now be made in detail to the preferred embodiments of the present disclosure, examples of which are illustrated in the accompanying drawings. While the disclosure will be described in conjunction with the preferred embodiments, it will be understood that they are not intended to limit the disclosure to these embodiments. On the contrary, the disclosure is intended to cover alternatives, modifications and equivalents, which may be included within the spirit and scope of the disclosure as defined by the appended claims. Furthermore, in the following detailed description of embodiments of the present disclosure, numerous specific details are set forth in order to provide a thorough understanding of the present disclosure. However, it will be recognized by one of ordinary skill in the art that the present disclosure may be practiced without these specific details. In other instances, well-known methods, procedures, components, and circuits have not been described in detail so as not to unnecessarily obscure aspects of the embodiments of the present disclosure. The drawings showing embodiments of the disclosure are semi-diagrammatic and not to scale and, particularly, some of the dimensions are for the clarity of presentation and are shown exaggerated in the drawing Figures. Similarly, although the views in the drawings for the ease of description generally show similar orientations, this depiction in the Figures is arbitrary for the most part. Generally, the disclosure can be operated in any orientation.

### Notation and Nomenclature:

Some portions of the detailed descriptions, which follow, are presented in terms of procedures, steps, logic blocks, processing, and other symbolic representations of operations on data bits within a computer memory. These descriptions and representations are the means used by those skilled in the data processing arts to most effectively convey the substance of their work to others skilled in the art. A procedure, computer executed step, logic block, process, etc., is here, and generally, conceived to be a self-consistent sequence of steps or instructions leading to a desired result. The steps are those requiring physical manipulations of physical quantities. Usually, though not necessarily, these quantities take the form of electrical or magnetic signals capable of being stored, transferred, combined, compared, and otherwise manipulated in a computer system. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussions, it is appreciated that throughout the present disclosure, discussions utilizing terms such as “processing” or “accessing” or “executing” or “storing” or “rendering” or the like, refer to the action and processes of a computer system, or similar electronic computing device, that manipulates and transforms data represented as physical (electronic) quantities within the computer system's registers and memories and other computer readable media into other data similarly represented as physical quantities within the computer system memories or registers or other such information storage, transmission or display devices. When a component appears in several embodiments, the use of the same reference numeral signifies that the component is the same component as illustrated in the original embodiment.

### Semiconductor Thermoelectric Module Charger for Mobile Computing Device

Semiconductor thermoelectric materials, such as Bi₂Te₃, Bi₂Se₃, PbTe and alloys thereof, are capable of converting a temperature difference directly into a voltage difference based on the Seeback effect. The conversion can be mathematically expressed as

V=α×ΔT,

where V is the voltage induced in response to a temperature difference ΔT across two locations on a thermoelectric material; α is the conversion coefficient which depends on the thermoelectric material's absolute temperature, material, and molecular structure.

The induced voltage V may be translated into a current and stored in rechargeable battery for subsequent use. Thus, the battery system of an electronic device may employ a semiconductor thermoelectric module comprising one or more thermoelectric materials which operates to covert the thermal energy generated during operation of the device into a current and store the current in the rechargeable battery. Not only can the recycling of the electrical energy increase the overall power efficiency of the device and thereby extend the usage time of the battery, additionally the conversion can also provide heat dissipation path and cool down the hot spot inside the electronic device.

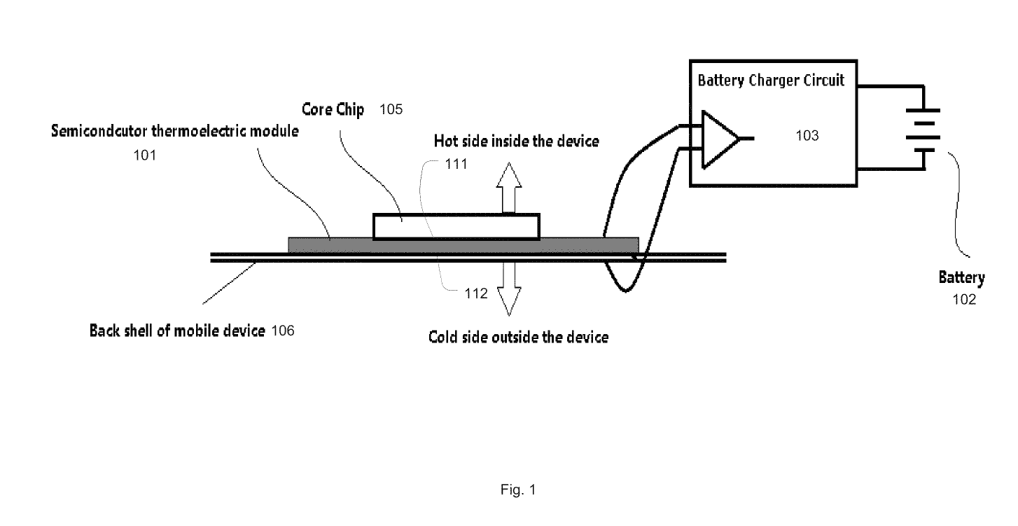

FIG. 1 illustrates a simplified configuration of an exemplary battery system 100 of a mobile computing device that comprises a semiconductor thermoelectric module 101 and a rechargeable battery 102 in accordance with an embodiment of the present disclosure. According to this embodiment, an upper surface 111 of the thermoelectric module 101 is in contact with a core chip 105, the core chip 105 being a CPU, a GPU, or a System-On-Chip (SOC), for instance. The lower surface of the thermoelectric module 101 is in contact with an exterior housing member, such as the back shell 106 or housing of the computing device. The thermoelectric module 101 is coupled to the rechargeable battery 102 through a charging circuit 103. The rechargeable battery 102 is configured to supply power to the computing device.

During operation, the core chip 105 generates heat and its temperature tends to increase with operating time due to the limited availability of heat dissipation paths in a compact design device. The heat can be transferred to the thermoelectric module 105 by conduction and can raise the temperature on the upper surface 111. On the other hand, the housing member 106 draws no current and maintains a much lower temperature, e.g. close to room temperature, due to the contact with the ambient environment. The temperature difference across the two surfaces, 111 and 112, can induce a voltage between the two surfaces based on the Seeback effect. According to the illustrated embodiment, through a suitable charging circuit, the voltage may be regulated and create a current to charge the rechargeable battery 102. Thus, the unwanted thermal energy generated by the core chip 105 is advantageously converted to electrical energy by the thermoelectric module 101 which can be reused to provide power to the computing device. Moreover, the thermal energy conversion advantageously provides a heat dissipation path and helps cool down the core chip 105, thereby improving the reliability and lifetime of the core chip 105.

The thermally induced voltage likely varies with the temperature and the continuous operation time of the core chip 105, as well as the ambient temperature. In some embodiments, the charging circuit 103 may be capable of charging the rechargeable battery 102 with a correspondingly variable charging voltage. However, in some other embodiments, the charging circuit 103 may comprise a voltage regulator and be capable of regulating the thermally induced voltage and output a predetermined voltage for charging. In some embodiments, the charging circuit 103 may include control logic which activates the charging only when the thermally induced voltage is above a threshold (ΔVₜₕ), and/or deactivate the charging when the rechargeable battery 102 is determined to be sufficiently charged.

The rechargeable battery 102 can be made of lead-acid, nickel cadmium (NiCd), nickel metal hydride (NiMH), lithium ion (Li-ion), or a lithium ion polymer (Li-ion polymer). The charging circuit 103 can be implemented as any circuit suitable for the specific configuration of the adopted rechargeable battery 102. For example, the charging circuit 103 may comprise a current-limiting resistor and a plurality of diodes (not shown).

In order to maximize heat conduction between the core chip 105 and the thermoelectric module 101, in some embodiments, the thermoelectric module 101 may be shaped to be conformal to the core chip 105. In some embodiments, a layer of thermal conductive adhesive material, such as epoxy, or an adhesive tape can be applied on the interfaces to promote contact between the materials and facilitate heat transfer.

Another possible heat generating source in a mobile computing device is the rechargeable battery, typically when charged by an external charger. For a battery, high temperatures, e.g. above 55° C., may constitute a detrimental condition because rate of corrosion, solubility of metal components, and self discharge tend to increase, thereby causing permanent capacity loss.

Thus, in some embodiments, a thermoelectric module may be disposed proximate to the rechargeable battery to recycle the electrical energy consumed by the battery internal resistance as well as to cool down the battery.

In some embodiments, a thermoelectric module may be disposed in the vicinity of, although not in direct contact with, a relatively hot member, e.g., a core chip or a rechargeable battery, in which configuration the heat is transferred by means of convection or radiation. In some embodiments, a thermoelectric module may be configured to be subject to heat transferred from more than one heat generating source. For example, it can be disposed proximate to two core chips and sense the combinational heat. In still some embodiments, more than one thermoelectric module can be encompassed in a computing device, each disposed proximate to a heat generating source and coupled to the rechargeable battery. In some other embodiments, a thermoelectric module can be configured as an exterior housing member of the computing device.

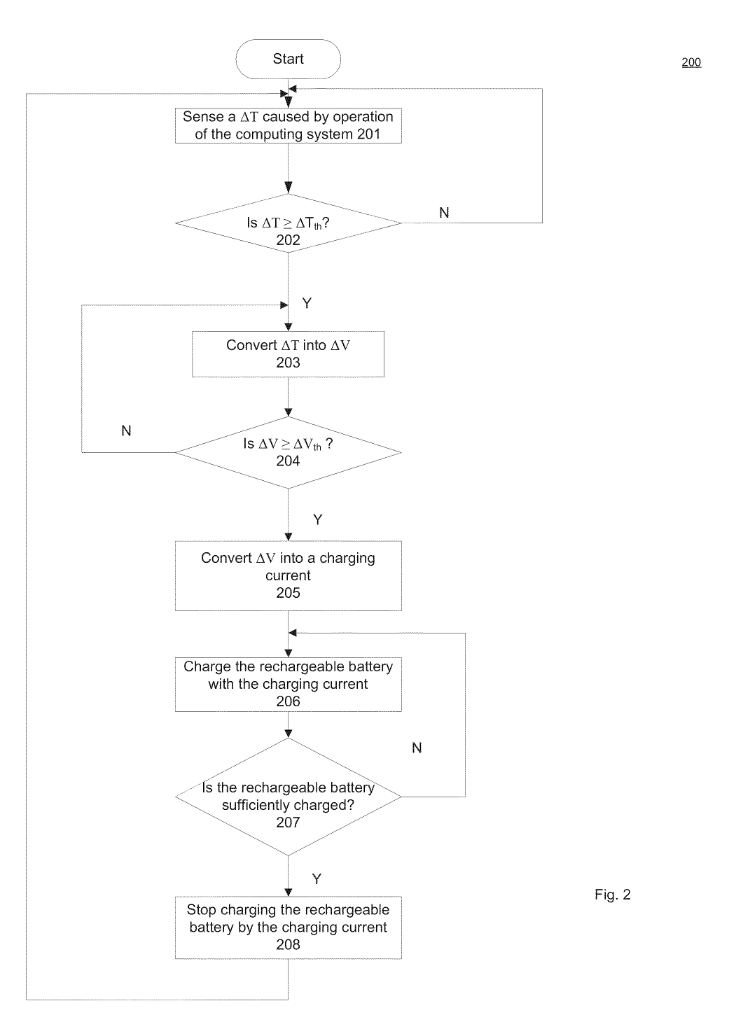

FIG. 2 is a flow diagram illustrating an exemplary process 200 for recycling thermal energy back into electrical energy in an electronic device by using a thermoelectric module and a rechargeable battery in accordance with an embodiment of the present disclosure. During operation, thermal energy can be generated by a power consuming component or a rechargeable battery, and a temperature difference (ΔT) can be sensed by a thermoelectric module at 201. According to this embodiment, if it is determined at 202 that the sensed ΔT is above a threshold ΔTₜₕ, the sensed ΔT can be converted into a voltage difference ΔV across the thermoelectric module at 203. ΔTₜₕ may be determined by a material property of the thermoelectric module indicating its sensitivity with respect to the energy conversion. The value of ΔV may have to be above a threshold value, ΔVₜₕ, for the ΔV to be translated into a current to charge rechargeable battery. The ΔVₜₕ may depend on the configurations of the charging circuit, the rechargeable battery and the associated electrical connections. If ΔV is determined to be greater than the ΔVₜₕ at 204, the voltage can drive a current at 205 and charge the rechargeable battery at 206.

When the rechargeable battery is determined to be sufficiently charged at 207, the control logic of the charging circuit may instruct to disconnect the thermoelectric module from the rechargeable circuit and deactivate any possible charging at 208. The foregoing steps are then repeated.

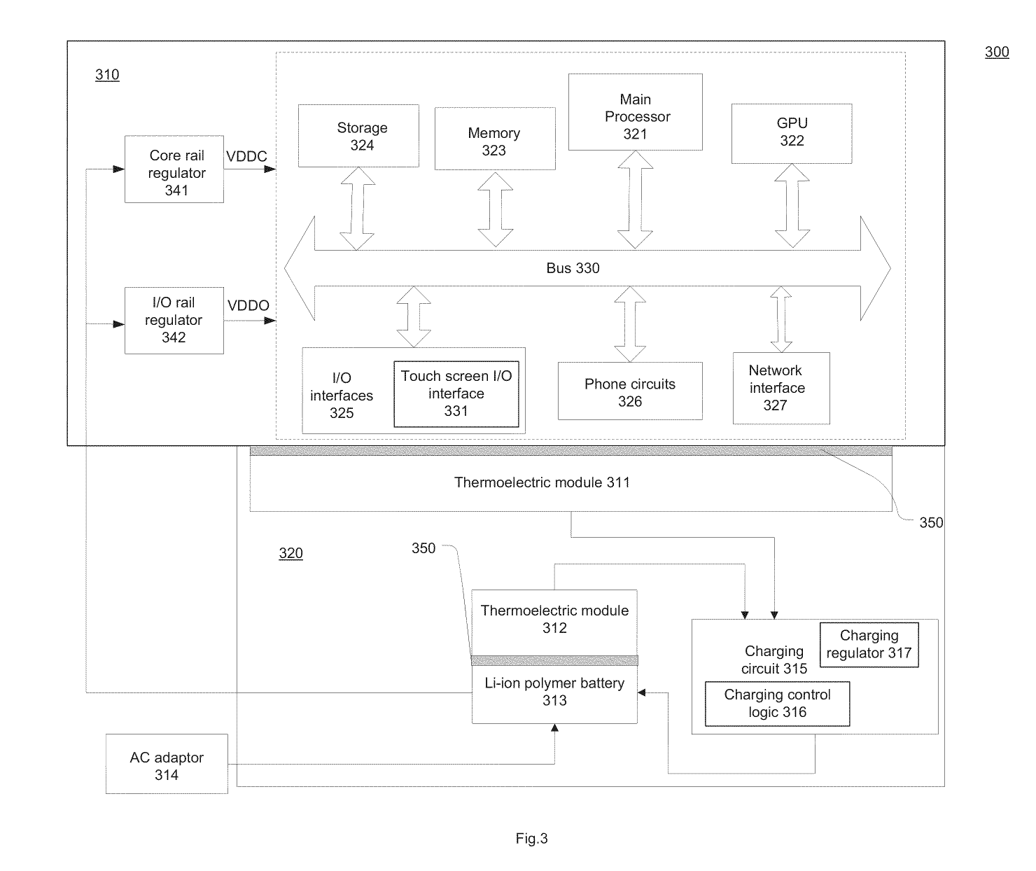

A thermoelectric module coupled to a rechargeable battery in accordance with the present disclosure can be applied in any type of electronic devices that may have an inhomogeneous temperature profile. FIG. 3 is a functional block diagram illustrating the configuration of a mobile computing device 300 that comprises two thermoelectric modules coupled with other functional components in accordance with an embodiment of the present disclosure. In some embodiments, the mobile computing device 300 can provide computing, communication and /or media play back capability. The mobile computing device 300 can also include other components (not explicitly shown) to provide various enhanced capabilities. The device 300 comprises a core chip 310 and a battery system 320 in accordance with the illustrated embodiment.

According to the illustrated embodiment in FIG. 3, the core chip may be a system-on-chip (SOC) 310 and comprises a main processor 321 for processing electrical data, a memory 323, an optional Graphic Processing Unit (GPU) 322, network interface 327, a storage device 324, phone circuits 326, I/O interfaces 325 which may include an interface 331 to communicate with a touch screen, a bus 330, and voltage regulators 341 and 342, for instance.

The main processor 321 can be implemented as one or more integrated circuits and can control the operation of mobile computing device 300. In some embodiments, the main processor 321 can execute a variety of operating systems and software programs and can maintain multiple concurrently executing programs or processes. The storage device 324 can store user data and application programs to be executed by main processor 321, such as video game programs, personal information data, media play back program. The storage device 324 can be implemented using disk, flash memory, or any other non-volatile storage medium.

Network or communication interface 327 can provide voice and/or data communication capability for mobile computing devices. In some embodiments, network interface can include radio frequency (RF) transceiver components for accessing wireless voice and/or data networks or other mobile communication technologies, GPS receiver components, or combination thereof. In some embodiments, network interface 327 can provide wired network connectivity instead of or in addition to a wireless interface. Network interface 327 can be implemented using a combination of hardware, e.g. antennas, modulators/demodulators, encoders/decoders, and other analog/digital signal processing circuits, and software components.

I/O interfaces 325 provide communication and control between the mobile computing device 300 with other external I/O devices (not shown), e.g. a computer, an external speaker dock or media playback station, a digital camera, a separate display device, a card reader, a disc drive, in-car entertainment system, a storage device, user input devices or the like.

According to the illustrated embodiment in FIG. 3, the battery system 320 comprises a thermoelectric module 311 attached to the core chip 310 to sense the heat that can be released from the core chip 310. The contact and thermal transfer may be improved by a layer of thermally conductive adhesive 350 disposed in between the core chip 310 and the thermoelectric module 311, as illustrated. The thermoelectric module 311 is coupled to the charging circuit 315. The battery system 320 further includes a Li polymer battery 313, attached with a second thermoelectric module 312 and coupled to the charging circuit 315.

The charging circuit 315 receives the induced voltages on the thermoelectric module 311 and 312, and output a regulated voltage compatible with the Li polymer battery 313 through the regulator 317 and the charging control logic 316. The Li polymer battery can also be charged through an AC adaptor 314.

The core rail regulator 341 regulates the power provided by the battery system to a core domain voltage VDDC which is distributed to the core domain logic in the core chip 310. The I/O rail regulator 322 regulates the power provided by the battery system to an I/O domain voltage VDDO which is distributed to the I/O domain logic. In some embodiments, the system may comprise more than two power domains to which the battery system 310 can supply power.

Although certain preferred embodiments and methods have been disclosed herein, it will be apparent from the foregoing disclosure to those skilled in the art that variations and modifications of such embodiments and methods may be made without departing from the spirit and scope of the disclosure. It is intended that the disclosure shall be limited only to the extent required by the appended claims and the rules and principles of applicable law.

What is claimed is:

1. A computing system comprising:
a first component operable to generate thermal energy during operation hereof;
a battery system comprising a thermoelectric module operable to sense the thermal energy generated by said first component, and further operable to convert said thermal energy generated by said first component into converted electrical energy.

2. The computing system as described in claim 1, wherein said battery system further comprises:
a rechargeable battery coupled with said thermoelectric module and operable to supply power to the first component; and
a charging circuit coupled with said rechargeable battery, and
wherein said thermoelectric module is operable to output said converted electrical energy as converted current and charge said rechargeable battery with said converted current through said charging circuit.

3. The computing system as described in claim 2, wherein said battery system further comprises a control circuit that is operable to:
activate charging said rechargeable battery by said thermoelectric module when said converted electrical energy is above a threshold value; and
deactivate the charging said rechargeable battery by said thermoelectric module when said rechargeable battery is determined to be sufficiently charged.

4. The computing system as described in claim 2 further comprising a second component, said second component maintaining a lower temperature than said first component during said operation of said first component; and wherein further said thermoelectric module is disposed proximate to said second component.

5. The computing system as described in claim 4, wherein an amount of said converted current is proportional to a temperature difference between said first component and said second component.

6. The computing system as described in claim 5, wherein said first component comprises a core chip, and wherein said second component is an exterior housing of the computing system.

7. The computing system as described in claim 2, wherein said first component is said rechargeable battery.

8. The computing system as described in claim 1, wherein said thermoelectric module is disposed proximate to said first component.

9. The computing system as described in claim 1, wherein said thermoelectric module is configured as an exterior housing of the computing system.

10. The computing system as described in claim 1, wherein said thermoelectric module comprises at least one thermal electrical material selected from a group consisting of Bi₂Te₃, Bi₂Se₃, PbTe and alloys thereof.

11. The computing system as described in claim 1, wherein said thermoelectric module is operable to convert said thermal energy into said converted electrical energy at a rate independent of an accumulative operating time of the battery system.

12. A power source for supplying power to a mobile computing system, said power source comprising:
a rechargeable battery;
an internal charging circuit;
a thermoelectric battery, coupled to said rechargeable battery, having a first surface and a second surface, and operable to:
sense a temperature difference between said first surface and said second surface;
generate electrical energy responsive to said temperature difference; and
charge said rechargeable battery with said electrical energy through said internal charging circuit.

13. The power source as described in claim 12, wherein said thermoelectric battery comprises at least one thermal electrical material selected from a group consisting of Bi₂Te₃, Bi₂Se₃, PbTe and alloys thereof; and wherein said rechargeable battery is a Li-ion polymer battery.

14. The power source as described in claim 12, wherein said temperature difference is caused by an operation of said mobile computing system.

15. The power source as described in claim 12, wherein said first surface of said thermoelectric battery is disposed proximate to a core chip of said mobile computing system.

16. The power source as described in claim 12, wherein said first surface of said thermoelectric battery is disposed proximate to said rechargeable battery; and wherein said second surface of said thermoelectric battery is disposed proximate to an exterior housing of said mobile computing system.

17. The power source as described in claim 12, wherein said internal charging circuit comprises charging control logic operable to:
activate charging said rechargeable battery with said electrical energy when said temperature difference is above a threshold value; and
deactivate said charging said rechargeable battery with said electrical energy when said rechargeable battery is determined to be sufficiently charged.

18. A method for supplying power to a mobile computing system, said method comprising:
sensing thermal energy generated by operation of said mobile computing system;
converting said thermal energy into an electrical current; and
charging a rechargeable battery with said electrical current, wherein said rechargeable battery is operable to supply power demanded by said mobile computing system.

19. The method as described in claim 18, wherein said converting said thermal energy into electrical current comprises:
creating a voltage difference between a first area and a second area of a thermoelectric module; and
producing said electrical current in response to said voltage difference.

20. The method as described in claim 19 further comprising:
activating said charging said rechargeable battery with said electrical current when said voltage difference is above a threshold value; and
deactivating said charging said rechargeable battery with said electrical current when said rechargeable battery is determined to be fully charged.

21. The method as described in claim 18, wherein said sensing thermal energy generated by operation of said mobile computing system comprises sensing thermal energy through thermal conduction.
